(19) United States
(12) Patent Application Publication
(10) Pub. No.: US 2005/0253470 A1
(43) Pub. Date: Nov. 17, 2005

(54) Direct current brushless vibration motor

(76) Inventor: Hung-Chi Tsai, DongGuan (CN)

Correspondence Address: John S. Egbert;Harrison & Egbert, 412 Main Street, 7th Floor, Houston, TX, 77002, US

(21) Appl. No.: 10/688,185

(22) Filed: Oct. 20, 2003

(30) Foreign Application Priority Data
Dec. 27, 2002 (CN) 02294163.0

(51) Int. Cl. H02K 7/06

(52) U.S. Cl. 310/81

(57) ABSTRACT

A direct current brushless vibration motor comprises a housing in which a stator is mounted. The stator is provided with a slot which is in turn provided in the inner wall with a series of pole teeth. A rotor is mounted in the slot of the stator and is formed of a magnetic cylindrical body, a rotary disk support mounted in the hollow interior of the magnetic cylindrical body, and a rotary shaft mounted in the center of the rotary disk support. The magnetic cylindrical body is provided in the outer wall with a series of pole pairs. The rotary disk support is provided with a plurality of weight through holes which are arranged unevenly to cause the rotor to engage in an unbalanced vibratory rotation.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a direct current vibration motor, and more particularly to a direct current brushless vibration motor which is designed to work with various digital devices to execute various vibration frequencies.

### BACKGROUND OF THE INVENTION

The conventional direct current vibration motor comprises a brush serving as a conductor between a revolving part of the motor and an external circuit. In light of the feature of the direct current motor being the rectifying action, the brush and the rectifier are used to reverse the current of the coil so as to enable the rotor to bring about rotation moment.

The conventional direct current vibration motor is complicated in construction and cannot be therefore easily miniaturized. The miniaturized vibration motor is widely used in a cell phone, beeper, palm computer, small toy, or small massager. As a result, the conventional direct current vibration motor is limited in its application.

The conventional direct current vibration motor cannot be made easily and is not cost-effective. In addition, the rejection rate of the conventional direct current vibration motor is relatively high. The performance of the direct current vibration motor depends on the assembly precision of the brush and the rectifier. A poor rectification is often resulted from a poor contact between the brush and the rectifier. In order to enhance the contact reliability and the wear resistance of the brush and the rectifier, the brush comprises a main body made of a precious metal, while the rectifier is provided with a cover made of a precious metal. As a result, the production of the conventional direct current vibration motor is complicated. Accordingly, the quality control of the product cannot be effectively executed.

In light of mechanical friction between the brush and the rectifier, the brush and the rectifier are susceptible to wear and electric corrosion, which tend to undermine the service life span of the motor. In addition, the motor in motion is apt to produce electrical or mechanical noise, thereby making the motor unsuitable for use in a high precision product, such as a mobile telephone or palm computer.

### BRIEF SUMMARY OF THE INVENTION

The primary objective of the present invention is to provide a direct current brushless vibration motor which is durable, cost-effective, and easy to make.

In keeping with the principle of the present invention, the foregoing objective of the present invention is attained by a direct current brushless vibration motor comprising a housing, a stator, and a rotor. The stator is mounted in the housing and is provided in the center with a rotor mounting slot which is provided in the inner wall with a plurality of pole teeth. The rotor is provided in the periphery with a plurality of pole pairs. The rotor mounting slot is provided in a segment of the inner wall thereof with a vibration source which is in turn provided with a plurality of pole teeth arranged at an interval greater than the interval of the pole teeth of the rest of the inner wall of the rotor mounting slot. As the rotor is excited to turn in accordance with an appropriate excitation order by the rotor, the pole pairs of the periphery of the rotor are eccentrically interfered to engage in vibratory rotation by the pole teeth of the vibration source.

The features, functions, and advantages of the present invention will be more readily understood upon a thoughtful deliberation of the following detailed description of a preferred embodiment of the present invention with reference to the accompanying drawings.

### BRIEF DESCRIPTION OF THE SEVERAL VIEWS OF THE DRAWINGS

FIG. 1 shows an exploded view of the preferred embodiment of the present invention.

FIG. 2 shows a top plan view of the rotor of the preferred embodiment of the present invention.

### DETAILED DESCRIPTION OF THE INVENTION

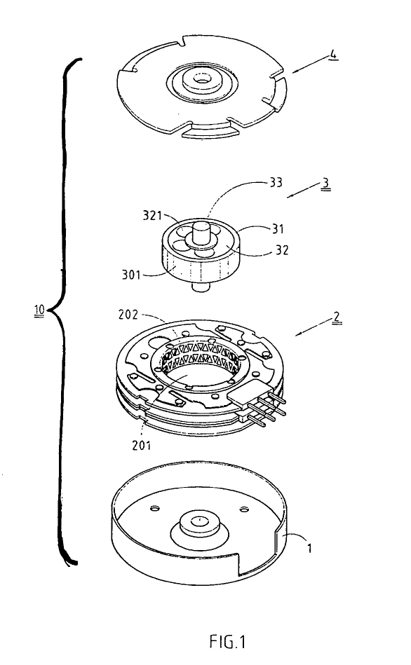

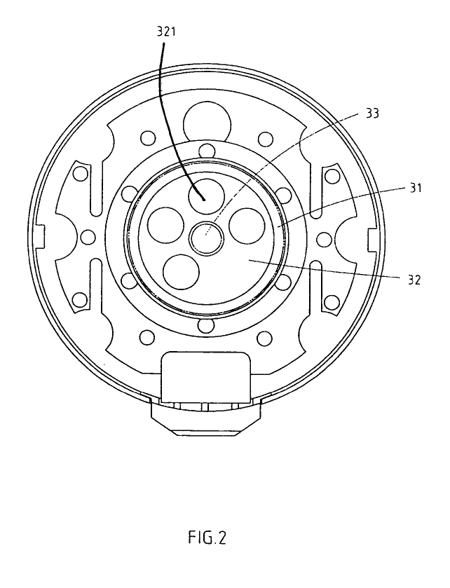

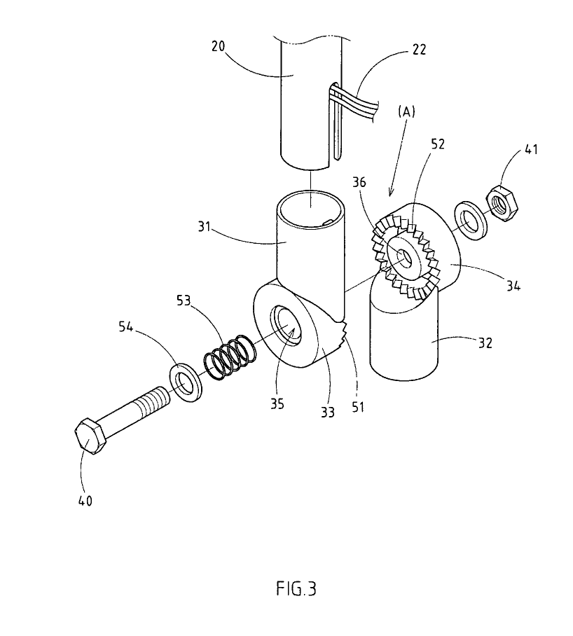

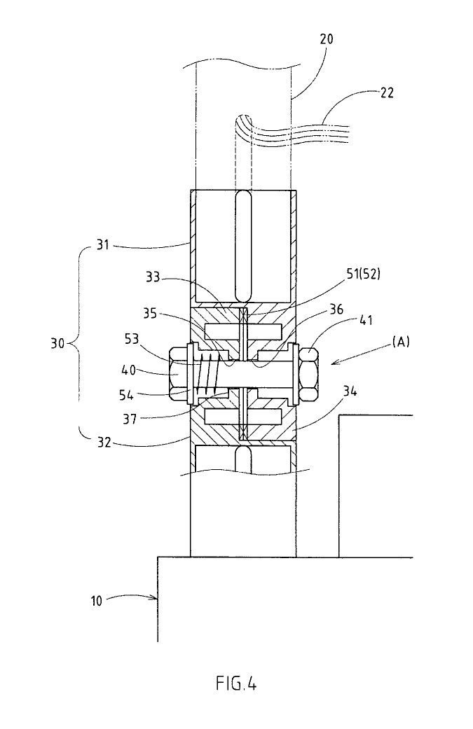

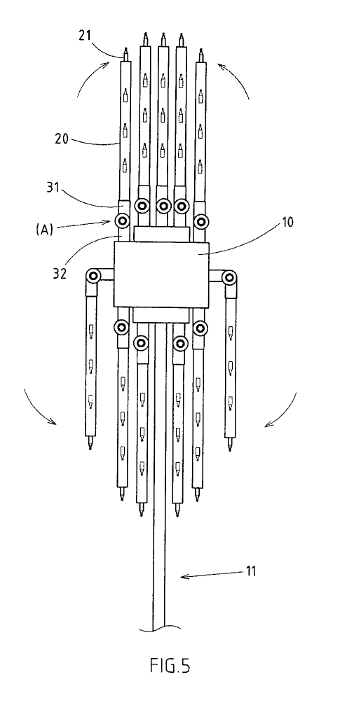

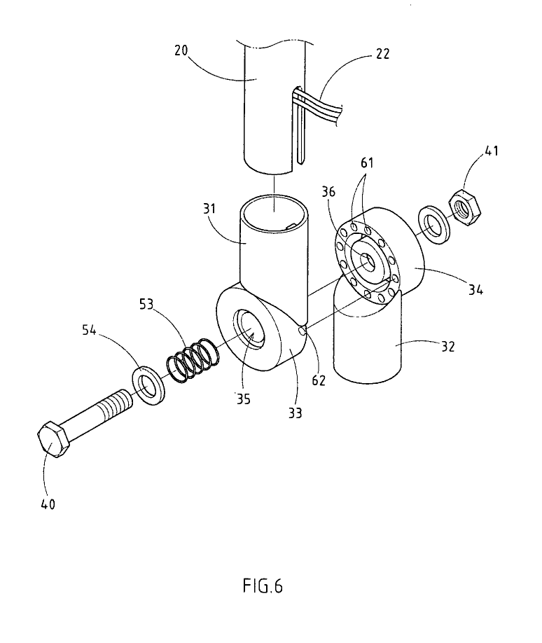

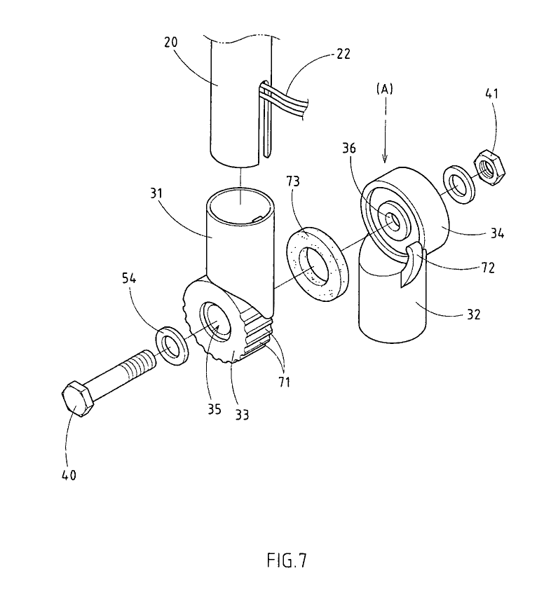

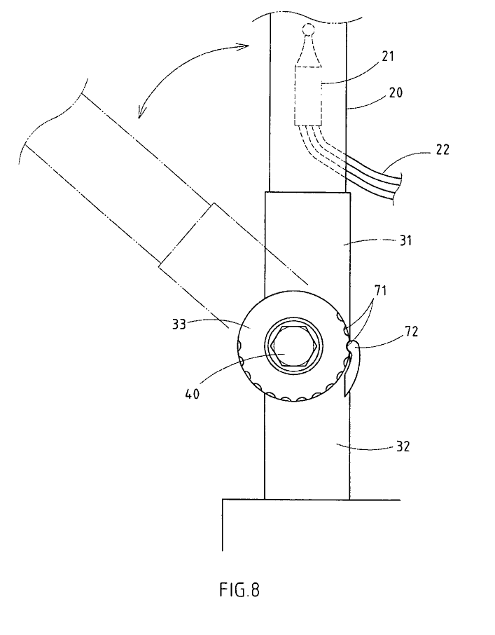

As shown in FIGS. 1 and 2, a direct current brushless vibration motor embodied in the present invention comprises a lower housing 1, a stator 2, a rotor 3, and an upper housing 4.

The stator 2 is mounted in the lower housing 1 and is provided in the center with a rotor mounting slot 201 which is provided with an inner wall with a series of pole teeth 202.

The rotor 3 is mounted in the rotor mounting slot 201 of the stator 2 and is provided in a periphery with a plurality of rotor pole pairs 301, each having the opposed poles. In another words, the periphery of the rotor 3 is formed of a magnetic cylindrical layer 31, with the pole pairs 301 being formed on the outer side of the magnetic cylindrical layer 31. The rotor 3 is provided in the interior with a rotary disk support 32, which is circumvented by the magnetic cylindrical layer 31. The rotor 3 is further provided in the center of the rotary disk support 32 with a rotary shaft 33. The rotary disk support 32 is provided with a plurality of weight through holes 321 which are distributed unevenly so as to cause the rotor 3 to engage in an unbalanced vibratory rotation.

The present invention makes use of a permanent magnet step-by-step motor as a basic structural unit. The direct current brushless vibration motor of the present invention is relatively simple in construction and is free of the mechanical contact between the brush and the rectifier. The control of the motor of the present invention is attained by an electronic circuit. The motor of the present invention is cost-effective. The rejection rate of the motor of the present invention is relatively low.

In light of the absence of the mechanical contact between the brush and the rectifier, the motor of the present invention is free of electrical or mechanical noise, as well as mechanical wear. As a result, the motor of the present invention is durable and reliable.

The speed of the step-by-step motor is directly proportional to the frequency of an input pulse. As a result, the speed of the motor can be easily changed by changing the pulse frequency. Accordingly, the modulation of the vibration frequency of the present invention can be attained by changing the pulse frequency. In another words, the vibration frequency of the motor of the present invention can be modulated in accordance with the requirement of a product. For example, the vibration frequency of the motor of the present invention can be modulated to suit the operational need of the bell of a mobile phone, or to keep a toy in a dynamic state.

The embodiment of the present invention described above is to be regarded in all respects as being illustrative and nonrestrictive. Accordingly, the present invention may be embodied in other specific forms without deviating from the spirit thereof. The present invention is therefore to be limited only by the scope of the following claim.

1. A direct current brushless vibration motor comprising:
a housing;
a stator mounted in said housing and comprised of a rotor mounting slot which is provided in an inner wall with a series of pole teeth, said pole teeth being arranged at an interval; and
a rotor comprised of a magnetic cylindrical body, a rotary disk support disposed in a hollow interior of said magnetic cylindrical body, and a rotary shaft mounted in a center of said rotary disk support, said magnetic cylindrical body being provided in an outer side with a series of rotor pole pairs, each pair having north and south magnetic poles, said rotor being mounted in said rotor mounting slot of said stator;
wherein said rotary disk support of said rotor is comprised of a plurality of weight through holes whereby said weight through holes are distributed unevenly to cause said rotor to engage in an unbalanced vibratory rotation.
